(19) United States
(12) Patent Application Publication
(10) Pub. No.: US 2020/0100236 A1
(43) Pub. Date: Mar. 26, 2020

(54) Message Construction for UE Capability Compression Using Delta Signaling

(71) Applicant: MediaTek Singapore Pte. Ltd., Singapore (SG)

(72) Inventor: Nathan Edward Tenny, San Jose, CA (US)

(21) Appl. No.: 16/564,107

(22) Filed: Sep. 9, 2019

Related U.S. Application Data
(60) Provisional application No. 62/734,278, filed on Sep. 21, 2018.

(51) Int. Cl. H04W 72/04; G06F 16/22

(52) U.S. Cl. CPC H04W 72/048; H04W 88/02; G06F 16/22; H04W 72/0453

(57) ABSTRACT

A method of UE capability signaling that allows flexible addition and deletion of capabilities relative to an indexed baseline capability is proposed. The network has access to a database of indexed capabilities, with each index value corresponding to a complete UE capability structure. UE reports index value X, but also indicates deltas to the capability indexed by X in portions of the capability structure, where the portions are constructed as a list of supported capabilities. Specifically, UE sends two lists along with the capability index, a “ToAddMod” list and a “ToRemove” list. Each entry in the “ToAddMod” list represents either a new entry to be added to the list, or a set of modified parameters for an existing entry in the list. Each entry in the “ToRemove” list represents an existing entry in the list, which should be considered as deleted.

### CROSS REFERENCE TO RELATED APPLICATIONS

This application claims priority under 35 U.S.C. § 119 from U.S. Provisional Application Number 62/734,278, entitled “Message Construction for UE capability Compression using Delta Signaling”, filed on Sep. 21, 2018, the subject matter of which is incorporated herein by reference.

### TECHNICAL FIELD

The disclosed embodiments relate generally to wireless communication, and, more particularly, to method of message construction for UE capability compression using delta signaling in LTE and NR systems.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partnership project (3GPP) network normally includes a hybrid of 2G/3G/4G systems. With the optimization of the network design, many improvements have developed over the evolution of various standards.

The UE capability signaling in LTE is notoriously large, with some UEs having capability signaling that threatens to exceed the 8 KB limit of a single protocol data unit (PDU) of the packet data convergence protocol (PDCP). Various means have been introduced in LTE to ameliorate the capability size problem, such as the “requested frequency band” list that limits which bands the UE should report its support for. However, with the increased use of carrier aggregation and the growth in supported band combinations, it remains a concern.

The signal bandwidth for next generation 5G new radio (NR) systems is estimated to increase to up to hundreds of MHz for below 6 GHz bands and even to values of GHz in case of millimeter wave bands. Furthermore, the NR peak rate requirement can be up to 20 Gbps, which is more than ten times that of LTE. A significant number of additional bands are introduced that the UE may support, e.g., covering so-called “mid-band” frequencies of approximately 3 GHz-6 GHz, millimeter-wave bands above approximately 24 GHz, and so on. NR is expected to have much larger capability signaling, due to the increased number of band combinations and the potential for very large lists of feature set combinations. It is clear that measures need to be taken to control the size of the NR capability, and to this end a study item has been spawned with the main objective being to investigate “index”- or “ID”-based methods of conveying the UE capability.

In the basic indexed scheme, instead of indicating the full UE capability, the UE would send a short identifier that represents the full capability. There are various candidates for the identifier, including a model number (e.g. the International Mobile Equipment Identifier and Software Version (IMEI-SV)) or a standardized identifier with no external meaning. A single index value is an effective way of compressing the UE capability, provided the index values are carefully administered so that every network has knowledge of every ID. Without such knowledge, networks will find themselves facing UEs that report their capabilities with an unknown value of the index, which means the network must fall back to requesting the entire UE capability. This of course defeats the purpose of the index and leaves the network with the problem of dealing with a potentially very large capability message.

A solution is sought to allow flexible addition and deletion of UE capabilities relative to the indexed UE capability.

### SUMMARY

A method of UE capability signaling that allows flexible addition and deletion of capabilities relative to an indexed baseline capability is proposed. The network has access to a database of indexed capabilities, with each index value corresponding to a complete UE capability structure. UE reports index value X, but also indicates deltas to the capability indexed by X in one or more portions of the capability structure, where one or more of the portions is constructed as a list of supported capabilities. Specifically, UE sends up to two lists along with the capability index, a “ToAddMod” list and a “ToRemove” list. Each entry in the “ToAddMod” list represents either a new entry to be added to the list, or a set of modified parameters for an existing entry in the list. Each entry in the “ToRemove” list represents an existing entry in the list, which should be considered as deleted.

In one embodiment, a UE transmits to a network entity an index value indicating a baseline capability. The UE transmits to the network entity at least one list of capability entries relative to the baseline capability. The UE operates according to the indicated operating capability of the UE. Each capability entry in the at least one list of capability entries comprises at least one of an indication of a capability value to remove from a list in the baseline capability, an indication of a capability value to modify in a list in the baseline capability, and an indication of a capability value to add to a list in the baseline capability. The indicated operating capability of the UE is related to the baseline capability according to the indications in the at least one list of capability entries relative to the baseline capability.

In another embodiment, a network entity obtains a database of index values indicating a plurality of baseline capabilities. The network entity receives, from the UE, an index value indicating a baseline capability. The network entity receives, from the UE, at least one list of capability entries relative to the baseline capability. The network entity stores the operating UE capability derived from the baseline capability and the at least one list of capability entries. Each capability entry in the at least one list of capability entries comprises at least one of an indication of a capability value to remove from a list in the baseline capability, an indication of a capability value to modify in a list in the baseline capability, and an indication of a capability value to add to a list in the baseline capability. The operating UE capability is related to the baseline capability according to the indications in the at least one list of capability entries relative to the baseline capability.

Other embodiments and advantages are described in the detailed description below. This summary does not purport to define the invention. The invention is defined by the claims.

### BRIEF DESCRIPTION OF THE DRAWINGS

FIG. 1 schematically shows a Public Land Mobile Network (PLMN) having a core network (CN) and a radio access network (RAN) supporting UE capability indication using delta signaling in accordance with one novel aspect.

FIG. 2 illustrates simplified block diagrams of a user equipment and a network entity in accordance with embodiments of the current invention.

FIG. 3 illustrates an example of baseline UE capability with a corresponding database of indexed UE capabilities.

FIGS. 4 and 5 illustrate an example of delta signaling for UE capability using ASN.1 structure.

FIG. 6 illustrates a sequence flow between a UE and a network for UE capability signaling with indexed baseline UE capability and delta signaling in accordance with one novel aspect.

FIG. 7 is a flow chart of a method of providing an operating capability of a UE using delta signaling in accordance with one novel aspect.

FIG. 8 is a flow chart of a method of deriving an operating capability of a UE using delta signaling in accordance with one novel aspect.

### DETAILED DESCRIPTION

Reference will now be made in detail to some embodiments of the invention, examples of which are illustrated in the accompanying drawings.

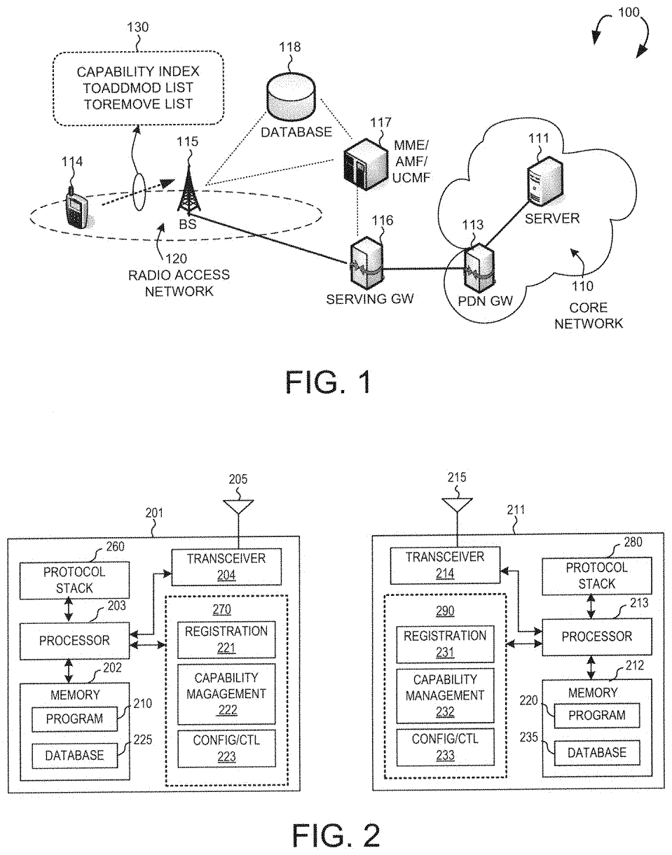

FIG. 1 schematically shows a Public Land Mobile Network (PLMN) 100 having a core network (CN) 110 and a radio access networks (RAN) 120 supporting UE capability indication using delta signaling in accordance with one novel aspect. PLMN 100 comprises application server 111 that provides various services by communicating with a plurality of user equipments (UEs) including UE 114. In the example of FIG. 1, application server 111 and a packet data network gateway (PDN GW or P-GW) 113 belong to part of a core network CN 110. UE 114 and its serving base station BS 115 belong to part of a radio access network RAN 120. RAN 120 provides radio access for UE 114 via a radio access technology (RAT). Application server 111 communicates with UE 114 through PDN GW 113, serving GW 116, and BS 115. In Non-Access Stratum (NAS) layer, a mobility management entity (MME) or an access and mobility management function (AMF) 117 communicates with BS 115, serving GW 116 and PDN GW 113 for access and mobility management of wireless access devices in LTE/NR network 100. UE 114 may be equipped with a radio frequency (RF) transceiver or multiple RF transceivers for different application services via different RATs/CNs. UE 114 may be a smart phone, a wearable device, an Internet of Things (IoT) device, and a tablet, etc.

The UE capability signaling in LTE is notoriously large, with some UEs having capability signaling that threatens to exceed the 8 KB limit of a single PDCP PDU. NR is expected to have much larger capability signaling, due to the increased number of band combinations and the potential for very large lists of feature set combinations. It is clear that measures need to be taken to control the size of the NR UE capability, e.g., by using “index”- or “ID”-based methods of conveying the UE capability. In the basic indexed scheme, instead of indicating the full UE capability, the UE would send a short identifier that represents the full capability. A single index value is an effective way of compressing the UE capability, provided the index values are carefully administered so that every network has knowledge of every ID.

However, guaranteeing that every network knows every index value is a daunting problem. Inevitably, there will be networks whose database of capability indices is not immediately updated to incorporate newer UE models. Moreover, UEs of the same model can have different capabilities, e.g. due to PLMN-specific settings, so the database must be even finer-grained than a list of all possible UE models. Accordingly, it has been suggested that the UE could signal a “delta” to the index; that is, there would be a database of indices corresponding to capability settings, and the UE would signal an index along with an indication of how its capabilities differ from the entry in the database. It is not trivial to see how the “delta” portion of this solution would be signaled. The capability is a complex structure, and indicating deltas with the same structure as the original capability signaling is inefficient.

In accordance with one novel aspect, a UE capability signaling method that allows flexible addition and deletion of capabilities relative to an indexed full baseline UE capability is proposed. In the example of FIG. 1, a node of the network (for instance, BS 115, MME/AMF/UCMF 117, or another element of the network) receives the UE capability signaling, either directly from UE 114 or by forwarding from another network element. The node of the network has access to a database 118 of indexed capabilities, with each index value corresponding to a complete UE capability structure. UE 114 reports index value X, but also indicates deltas to the capability indexed by X in one or more portions of the capability structure, where the portions is constructed as a list of supported capabilities. Specifically, as depicted by 130, UE 114 sends up to two lists along with the capability index, a “ToAddMod” list and a “ToRemove” list. Each entry in the “ToAddMod” list represents either a new entry to be added to the list, or a set of modified parameters for an existing entry in the list. Each entry in the “ToRemove” list represents an existing entry in the list, which should be considered as deleted. Either of the lists may be empty or absent; for instance, if the “ToAddMod” list is empty or absent, the network may infer that the UE has no capabilities to add or modify relative to the capability represented by the capability index. The delta signaling could be applied to any of the UE capability fields that are structured as lists.

FIG. 2 illustrates simplified block diagrams of wireless devices, e.g., a UE 201 and network entity 211 in accordance with embodiments of the current invention. Network entity 211 may be a base station combined with an MME or AMF and/or additional elements of a CN, such as a UE Capability Management Function (UCMF). Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends them out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes a set of control functional modules and circuit 290. Registration circuit 231 handles registration and attach procedure. Capability management circuit 232 handles capability management functionalities including message construction for UE capability compression using delta signaling. Configuration and control circuit 233 provides different parameters to configure and control UE. In one example, network entity 211 has access to a database of indexed baseline capabilities, and thus can derive UE operation capability from the indexed baseline capability and delta signaling related to indications of the baseline capability.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), field programmable gate array (FPGA) circuits, and other type of integrated circuits (ICs), and/or state machines. A processor in association with software may be used to implement and configure features of UE 201.

UE 201 also comprises a set of functional modules and control circuits to carry out functional tasks of UE 201. Protocol stacks 260 may comprise Non-Access-Stratum (NAS) layer to communicate with an MME or an AMF entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuits 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network. In one example, system modules and circuits 270 comprise registration module 221 that performs registration and attach procedure with the network, a capability management module 222 that handles capability management functionalities including message indication for UE capability compression using delta signaling, and a configuration and control module 223 that handles configuration and control parameters. In one example, UE 201 indicates its UE operation capability by providing an index indicating to a baseline capability and delta signaling providing additional indications related to the baseline capability.

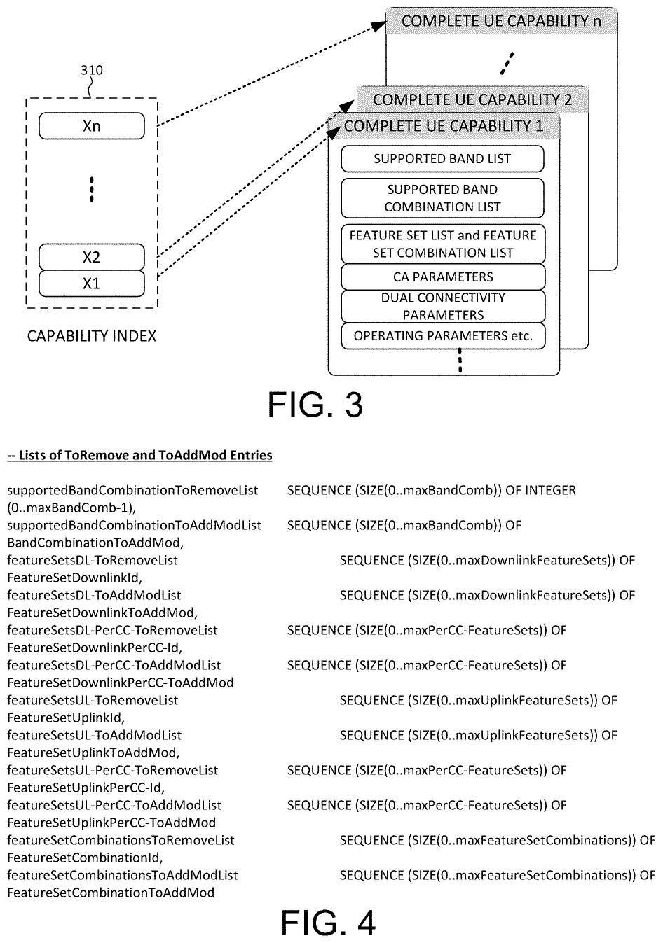

FIG. 3 illustrates an example of baseline UE capability with a corresponding database of indexed UE capabilities. UE capability information is a radio resource control (RRC) message that UE sends to network (in most cases during an initial registration process). In some embodiments, the UE capability information may be embedded in a message of another protocol layer, for instance, a NAS message. It informs the network on all the details of UE capabilities. As LTE/NR release goes higher and more features are added, UE capability information has become the longest and most complicated radio message. From very high-level view of UE capability information, the message structure may comprise the following: supported band list, supported band combination list, feature set list, feature set combination list, carrier aggregation (CA) parameters, dual connectivity parameters, operating parameters for individual protocol layers (for instance, PDCP parameters, RLC parameters, MAC parameters, PHY parameters, and so on), etc. Some parameters may be maintained separately for uplink and downlink, and/or individually for separate component carriers (CCs) of a CA configuration. In accordance with one novel aspect, a collection of UE capability information is maintained in a database, where each of the UE capabilities becomes a baseline capability containing one variation of complete UE capability information.

In addition, each of the UE capabilities is associated to a corresponding capability index value, which is also maintained in the database. For example, table 310 stores the capability index values, and index value X1 indicates a baseline UE capability 1, index value X2 indicates a baseline UE capability 2 . . . and index value Xn indicates a baseline UE capability n. When the network has access to such database, the network can obtain the complete baseline UE capability information from its corresponding index value. As a result, with the additional help from delta signaling, the network can derive UE's operating capability from an index value of its baseline capability plus certain modification to the baseline capability.

The UE capability is a complex structure, and indicating deltas with the same structure as the original capability signaling is inefficient. As one example, the field rf-Parameters in the UE capability comprises a list of supported bands and a list of supported band combinations. A UE that wished to indicate “support for index value X, with the addition of band Y and band combinations A and B” could reasonably signal a structure comprising the value X, a supported band list containing Y, and a supported band combination list containing A and B; however, it is less clear how to signal “support for index value X, with the deletion of band W and band combination C”, because there is no signaling in the existing capability structure to indicate unsupported bands or combinations. Similarly, the UE's capability to support various features is indicated by structures called “feature sets” and “feature set combinations” that are sent in the fields featureSets and featureSetCombinations of the UE capability, respectively; it is reasonably clear how additional feature sets and/or feature set combinations could be signaled, but less clear how the capability structure could be exploited to show non-support of a feature set or feature set combination that is supported in the indexed capability.

Assume the network has access to a database of indexed capabilities, with each index value corresponding to a complete UE capability structure. Consider a UE that reports index value X, but also needs to indicate deltas to the capability indexed by X in one or more portions of the capability structure, where the portion is constructed as a list of supported capabilities. A typical example of a “portion” for this purpose would be the band combination list, the feature set combination list, etc. If portions of the capability that are not structured as lists (for instance, the physical layer parameters, which comprises a set of individual parameters having no list structure) need to be indicated in the delta signaling, then UE simply sends a new copy of those portions of the capability signaling. For example, the physical layer parameters are just a set of individual parameters, which are not structured as a list, e.g., not an indexed array of similar entries. If UE needs to indicate a change in the physical layer parameters, the UE simply sends a new copy of the IE Phy-Parameters, which is not structured as a list and is inexpensive to duplicate over the air.

In accordance with one novel aspect, for the affected list, the concerned UE will send up to two lists along with the capability index: a “ToAddMod” (for “add and modify”) list and a “ToRemove” list. This is generally similar to the use of lists in the delta signaling for UE configurations in the RRC protocol. The semantics of the list entries are defined as follows: Each entry in the “ToAddMod” list represents either a new entry to be added to the list, or a set of modified parameters for an existing entry in the list. The two cases may be differentiated, for example, by including an ID of an existing entry to indicate a modification, whereas a new entry to be added will either include no ID or an ID with a new value not corresponding to any existing entry. Each entry in the “ToRemove” list represents an existing entry in the list, which should be considered as deleted. The entry must have an ID to indicate which list entry should be deleted, and typically may not include any other information. The ID may be an entry number in the list or a separate identifier for a specific list entry. Note that a list entry may or may not have an ID as part of the entry. For example, the “ID” for feature set list is just the entry number in the list.

For example, suppose the UE sends index value X, and wishes to indicate support for new band combinations Y and Z (which are not included in the capabilities indexed by X), but no support for an existing band combination W (which is included in the capabilities indexed by X). This UE would need to send the following information: the index value X; a BandCombinationToRemoveList containing an entry indicating the position of W in the list of capabilities indexed by X; and a BandCombinationToAddModList containing new entries for band combinations Y and Z. In some embodiments, the “ToAdd” and “ToModify” information could be sent as two separate lists instead of being combined. In this example, in such a case, the “ToModify” list would be empty or absent.

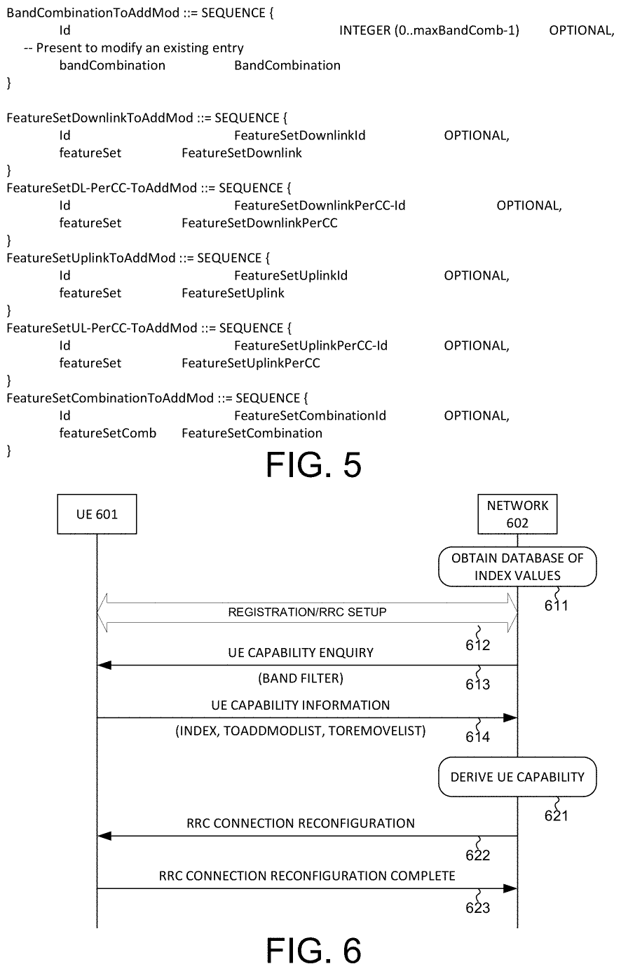

FIGS. 4 and 5 illustrate an example of delta signaling for UE capability using ASN.1 structure. The delta signaling could be applied to any of the capability fields that are structured as lists, for example, the band list, the band combination list, the feature set list, the feature set combination list, etc. Assuming it applies to the band combination list, the feature set lists for uplink and downlink, and the feature set combination list (including the feature set combinations per component carrier), a possible ASN.1 structure is illustrated in FIG. 4 and FIG. 5. Note that this ASN.1 structure may be varied in numerous ways, e.g. separating the “ToAddMod” lists into separate “ToAdd” and “ToModify” lists as discussed above.

FIG. 6 illustrates a sequence flow between a UE and a network for UE capability signaling with indexed baseline UE capability and delta signaling in accordance with one novel aspect. In step 611, network 602 obtains a database of indexed capabilities, with each index value corresponding to a complete UE capability structure, e.g., a baseline UE capability. Step 611 may represent provisioning of a database during configuration of the network, for example. In step 612, UE 601 performs registration/attach and/or RRC setup procedure with the network. In step 613, network 602 sends a UE capability enquiry to UE 601, the network could provide a band filter with “requested frequency bands” to reduce UE capability signaling overhead. In step 614, UE 601 transmits UE capability information to the network. Instead of sending the entire UE operating capability, UE 601 sends an index value of a corresponding baseline UE capability, together with up to two lists along with the index: a ToAddMod list and a ToRemove list. In step 621, network 602 derives the UE operating capability from the received capability index, the ToAddMod list, and the ToRemove list. In step 622, network 602 sends an RRC connection reconfiguration message to UE 601 based on the UE capability. In step 623, UE 601 sends an RRC connection reconfiguration complete message back to the network.

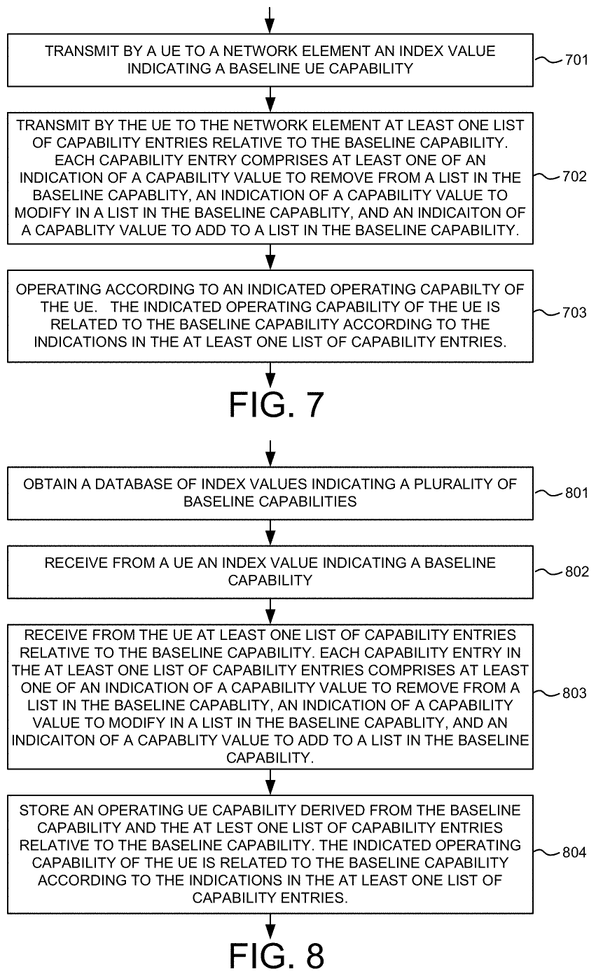

FIG. 7 is a flow chart of a method of providing an operating capability of a UE using delta signaling in accordance with one novel aspect. In step 701, a UE transmits to a network entity an index value indicating a baseline capability. In step 702, the UE transmits to the network entity at least one list of capability entries relative to the baseline capability. Each capability entry in the at least one list of capability entries comprises at least one of an indication of a capability value to remove from a list in the baseline capability, an indication of a capability value to modify in a list in the baseline capability, and an indication of a capability value to add to a list in the baseline capability. In step 703, the UE operates according to the indicated operating capability of the UE. The indicated operating capability of the UE is related to the baseline capability according to the indications in the at least one list of capability entries relative to the baseline capability.

FIG. 8 is a flow chart of a method of deriving an operating capability of a UE using delta signaling in accordance with one novel aspect. In step 801, a network entity obtains a database of index values indicating a plurality of baseline capabilities. In step 802, the network entity receives, from the UE, an index value indicating a baseline capability. In step 803, the network entity receives, from the UE, at least one list of capability entries relative to the baseline capability. Each capability entry in the at least one list of capability entries comprises at least one of an indication of a capability value to remove from a list in the baseline capability, an indication of a capability value to modify in a list in the baseline capability, and an indication of a capability value to add to a list in the baseline capability. In step 804, the network entity stores the operating UE capability derived from the baseline capability and the at least one list of capability entries. The operating UE capability is related to the baseline capability according to the indications in the at least one list of capability entries relative to the baseline capability.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method of indicating an operating capability of a User Equipment (UE), comprising:
transmitting, by the UE to a network entity, an index value indicating a baseline capability;
transmitting, by the UE to the network entity, at least one list of capability entries relative to the baseline capability, wherein each capability entry in the at least one list of capability entries comprises at least one of an indication of a capability value to remove from a list in the baseline capability, an indication of a capability value to modify in a list in the baseline capability, and an indication of a capability value to add to a list in the baseline capability; and
operating according to the indicated operating capability of the UE, wherein the indicated operating capability of the UE is related to the baseline capability according to the indications in the at least one list of capability entries relative to the baseline capability.

2. The method of claim 1, wherein the baseline capability comprises a list of supported band combinations.

3. The method of claim 1, wherein the baseline capability comprises a list of supported feature sets.

4. The method of claim 1, wherein the baseline capability comprises a list of supported feature sets per component carrier.

5. The method of claim 1, wherein the baseline capability comprises a list of supported feature set combinations.

6. The method of claim 1, wherein the baseline capability comprises a list of supported frequency bands.

7. The method of claim 1, wherein a capability value to remove from a list in the baseline capability is identified in the at least one list of capability entries relative to the baseline capability by an index of the capability value in the list in the baseline capability.

8. The method of claim 1, wherein a capability value to modify in a list in the baseline capability is identified in the at least one list of capability entries relative to the baseline capability by an index of the capability value in the list in the baseline capability.

9. A User Equipment (UE), comprising:
a transmitter that transmits an index value indicating a baseline capability to a network entity, wherein the UE also transmits at least one list of capability entries relative to the baseline capability to the network entity, wherein each capability entry in the at least one list of capability entries comprises at least one of an indication of a capability value to remove from a list in the baseline capability, an indication of a capability value to modify in a list in the baseline capability, and an indication of a capability value to add to a list in the baseline capability; and
a UE capability management circuit that determines an indicated operating capability of the UE, wherein the indicated operating capability of the UE is related to the baseline capability according to the indications in the at least one list of capability entries relative to the baseline capability.

10. The UE of claim 9, wherein the baseline capability comprises a list of supported band combinations.

11. The UE of claim 9, wherein the baseline capability comprises a list of supported feature sets.

12. The UE of claim 9, wherein the baseline capability comprises a list of supported feature sets per component carrier.

13. The UE of claim 9, wherein the baseline capability comprises a list of supported feature set combinations.

14. The UE of claim 9, wherein the baseline capability comprises a list of supported frequency bands.

15. The UE of claim 9, wherein a capability value to remove from a list in the baseline capability is identified in the at least one list of capability entries relative to the baseline capability by an index of the capability value in the list in the baseline capability.

16. The UE of claim 9, wherein a capability value to modify in a list in the baseline capability is identified in the at least one list of capability entries relative to the baseline capability by an index of the capability value in the list in the baseline capability.

17. A method of storing an operating capability of a User Equipment (UE) by a network entity, comprising:
obtaining a database of index values indicating a plurality of baseline capabilities;
receiving, from the UE, an index value indicating a baseline capability;
receiving, from the UE, at least one list of capability entries relative to the baseline capability, wherein each capability entry in the at least one list of capability entries comprises at least one of an indication of a capability value to remove from a list in the baseline capability, an indication of a capability value to modify in a list in the baseline capability, and an indication of a capability value to add to a list in the baseline capability; and
storing the operating UE capability derived from the baseline capability and the at least one list of capability entries, wherein the operating UE capability is related to the baseline capability according to the indications in the at least one list of capability entries relative to the baseline capability.

18. The method of claim 17, wherein the baseline capability comprises at least one of a list of supported band combinations, a list of supported feature sets, a list of supported feature sets per component carrier, a list of supported feature set combinations, and a list of supported frequency bands.

19. The method of claim 17, wherein a capability value to remove from a list in the baseline capability is identified in the at least one list of capability entries relative to the baseline capability by an index of the capability value in the list in the baseline capability.

20. The method of claim 17, wherein a capability value to modify in a list in the baseline capability is identified in the at least one list of capability entries relative to the baseline capability by an index of the capability value in the list in the baseline capability.
